(19) United States
(12) Patent Application Publication
(10) Pub. No.: US 2015/0241598 A1
(43) Pub. Date: Aug. 27, 2015

(54) METHOD OF DIVIDING IRRADIANCE REGIONS BASED ON ROTATED EMPIRICAL ORTHOGONAL FUNCTION

(71) Applicants: State Grid Corporation of China, Beijing (CN); Gansu Electric Power Company of State Grid, Lanzhou (CN); Wind Power Technology Center of Gansu Electric Power Company, Lanzhou (CN)

(72) Inventors: NING-BO WANG, Beijing (CN); LIANG LU, Beijing (CN); YAN-HONG MA, Beijing (CN); QIANG ZHOU, Beijing (CN); DING-MEI WANG, Beijing (CN); XU CHENG, Beijing (CN); LONG ZHAO, Beijing (CN); KUN DING, Beijing (CN); SHI-YUAN ZHOU, Beijing (CN); GUANG-TU LIU, Beijing (CN); QING-QUAN LV, Beijing (CN); ZHAO CHEN, Beijing (CN)

(21) Appl. No.: 14/619,079

(22) Filed: Feb. 11, 2015

(30) Foreign Application Priority Data
Feb. 25, 2014 (CN) 201410064851.2

(51) Int. Cl. G01W 1/00; G01J 1/42

(52) U.S. Cl. CPC G01W 1/00; G01J 1/42

(57) ABSTRACT

A method of dividing irradiance regions based on rotated empirical orthogonal function includes following steps. A standardized matrix averaging on annual total radiation amount data is performed. An empirical orthogonal function decomposition on an annual total radiation variable field matrix is performed based on the standardized matrix averaging result of the annual total radiation amount data. A variance contribution rate and an accumulative variance contribution rate are calculated by rotating a load matrix and a factor matrix according to a varimax orthogonal rotation principle based on the empirical orthogonal function decomposition result of the annual total radiation variable field matrix. The irradiance regions are divided according to results of the variance contribution rate and the accumulative variance contribution rate.

### BACKGROUND

1. Technical Field

The present disclosure relates to a method of dividing irradiance regions based on rotated empirical orthogonal function (REOF).

2. Description of the Related Art

With the rapid development of photovoltaic power industry, China has entered a period of rapidly developing photovoltaic power.

In the photovoltaic power plant, the solar radiation is transferred into the electrical energy by the photovoltaic power panels. Thus it is essential to divide the irradiance regions at which the photovoltaic power panels are located based on the solar radiation. However, at present, the method of dividing the irradiance regions is poor in stability, low in energy conversion efficiency, and poor in environmental protection.

What is needed, therefore, is a method of dividing irradiance regions that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flow chart of one embodiment of a method of dividing irradiance regions based on EOF.

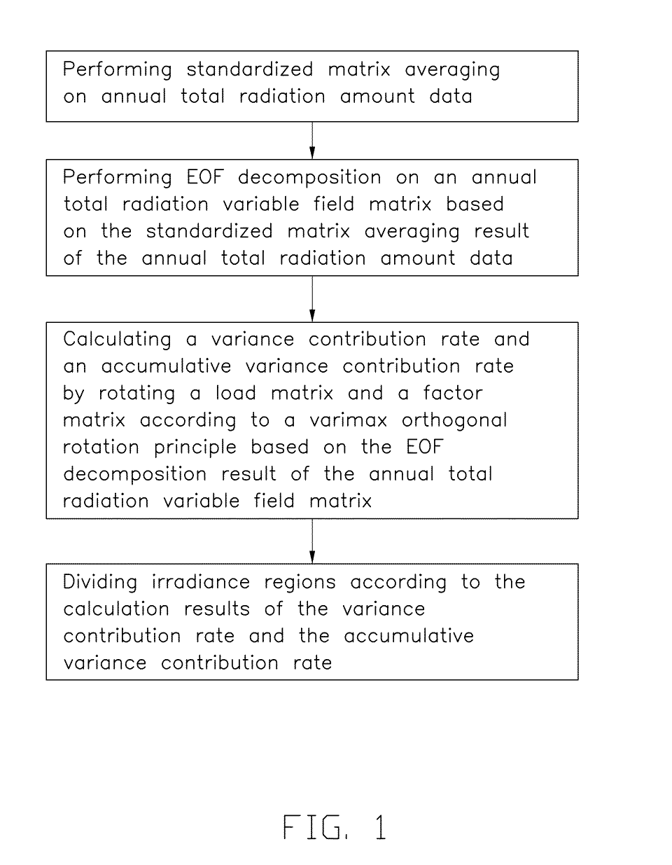

FIG. 2 shows a schematic view of one embodiment of a spatial distribution map of a rotating load vector in total amount of radiation in one year in method of FIG. 1.

FIG. 3 shows a schematic view of one embodiment of a time coefficient distribution map of a rotating load vector in total amount of radiation in one year of FIG. 1.

FIG. 4 shows a schematic view of another embodiment of a spatial distribution map of a rotating load vector in total amount of radiation in one year in method of FIG. 1.

FIG. 5 shows a schematic view of another embodiment of a time coefficient distribution map of a rotating load vector in total amount of radiation in one year of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

A method of dividing irradiance regions based on rotated empirical orthogonal function comprises:

step (a), performing standardized matrix averaging on annual total radiation amount data;

step (b), performing EOF decomposition on an annual total radiation variable field matrix based on the standardized matrix averaging result of the annual total radiation amount data;

step (c), calculating a variance contribution rate and an accumulative variance contribution rate by rotating a load matrix and a factor matrix according to a varimax orthogonal rotation principle based on the EOF decomposition result of the annual total radiation variable field matrix; and

step (d), dividing irradiance regions according to the calculation results of the variance contribution rate and the accumulative variance contribution rate.

In step (a), the performing standardized matrix averaging on annual total radiation amount data comprising:

$$\overline{x} = \frac{1}{m} \frac{1}{n} {\sum }_{i = 1}^{m} {\sum }_{j = 1}^{n} {x}_{ij}^{′} ,$$

wherein x′ᵢⱼ represents the radiation data 1≦i≦m, 1≦j≦n, m represents the length of time, n represents the quantity of observation stations. Thus:

$${x}_{ij} = \frac{{x}_{ij}^{′} - \overline{x}}{\sqrt{{\sum }_{i = 1}^{m} {\sum }_{j = 1}^{n} {( {x}_{ij}^{′} - \overline{x} )}^{2}}} ,$$

wherein 1≦i≦m, 1≦j≦n.

In step (b), the performing EOF decomposition on an annual total radiation variable field matrix comprises:

(b11), constructing the radiation data into an annual total radiation variable matrix X_{n×m}:

$$X = [ \begin{matrix}{x}_{11} & {x}_{12} & … & {x}_{1 j} & … & {x}_{1 n} \\ {x}_{21} & {x}_{22} & … & {x}_{2 j} & … & {x}_{2 n} \\ ⋮ & ⋮ & & ⋮ & & ⋮ \\ {x}_{i 1} & {x}_{i 2} & & {x}_{ij} & & {x}_{in} \\ ⋮ & ⋮ & & ⋮ & & ⋮ \\ {x}_{m 1} & {x}_{m 2} & … & {x}_{mj} & … & {x}_{mm}\end{matrix} ] ; \qquad ( 1 )$$

wherein n represents space points, m represents time points.

(b12) decomposing the annual total radiation variable matrix into a total of products of space functions and time functions:

X_{n×m}=V_{n×n}T_{n×m} (2);

wherein each column of V_{n×n} represents normalized feature vectors of matrix

$$\frac{1}{m} {XX}^{T} ,$$

and X^{T} is transposed matrix of X; T_{n×m} represents weighting coefficients of eigenvectors.

The T_{n×m} can be standardized as F: F=Λ^{-1/2}·T, wherein Λ is a diagonal matrix of eigenvalues of the matrix

$$\frac{1}{m} {XX}^{T} .$$

While L=V·Λ^{1/2} thus matrix A=V·Λ^{1/2}·Λ^{-1/2}·T=LF, wherein L is factor loading matrix, matrix F is factor matrix, and L is an correlation matrix between matrix A and matrix F.

In step (c), the matrix L and the matrix F are rotated based on varimax orthogonal rotation principle, wherein a sum of relative variances of square elements in each column of matrix L is maximum. In one embodiment, while the first p factors are selected, then:

$$S = {\sum }_{j = 1}^{p} [ \frac{1}{n} {\sum }_{i = 1}^{n} {( \frac{{l}_{ij}^{2}}{{h}_{i}^{2}} )}^{2} - ( \frac{1}{n} {\sum }_{i = 1}^{n} {( \frac{{l}_{ij}^{2}}{{h}_{i}^{2}} )}^{2} ]$$

is maximum;
wherein

$${h}_{i}^{2} = {\sum }_{j = 1}^{p} {l}_{ij}^{2} ,$$

lᵢⱼ is the element of matrix L.

The calculation of variance contribution rate and the accumulative variance contribution rate can satisfy:

$${\sum }_{i = 1}^{m} {v}_{ik} {v}_{il} = 1 , while k = 1 \\ {\sum }_{j = 1}^{n} {t}_{kj} {v}_{lj} = 0 , while k \neq 1 ; \qquad ( 3 )$$

wherein vₖ is the feature vectors, and the variance contribution rate of vₖ is:

$$\frac{{λ}_{k}}{{\sum }_{k = 1}^{m} {λ}_{k}} \times 100 \% ;$$

the cumulative variance contribution rate of the first k spaces is:

$$\frac{{\sum }_{k = 1}^{k} {λ}_{k}}{{\sum }_{k = 1}^{m} {λ}_{k}} \times 100 \% .$$

The significance test of cumulative contribution ratio can be preformed by calculating error range of eigenvalues based on North proposed method. The error range of eigenvalue λᵢ is:

$${e}_{j} = {{λ}_{j} ( \frac{2}{n} )}^{\frac{1}{2}} , \qquad ( 4 )$$

wherein n is the sample size.

While the adjacent two eigenvalues λᵢ and λᵢ₊₁ satisfy:

λᵢ−λᵢ₊₁≧eⱼ (5),

thus the rotated empirical orthogonal functions corresponding to the two eigenvalues λᵢ and λᵢ₊₁ are valuable signals.

TABLE 1
variance contributions of the first 5 elements in the
annual total radiation amount data after being rotated

| REOF No. | contribution rate | cumulative contribution rate |
|---|---|---|
| 1 | 0.288 | 0.288 |
| 2 | 0.167 | 0.455 |
| 3 | 0.117 | 0.572 |
| 4 | 0.069 | 0.641 |
| 5 | 0.060 | 0.701 |

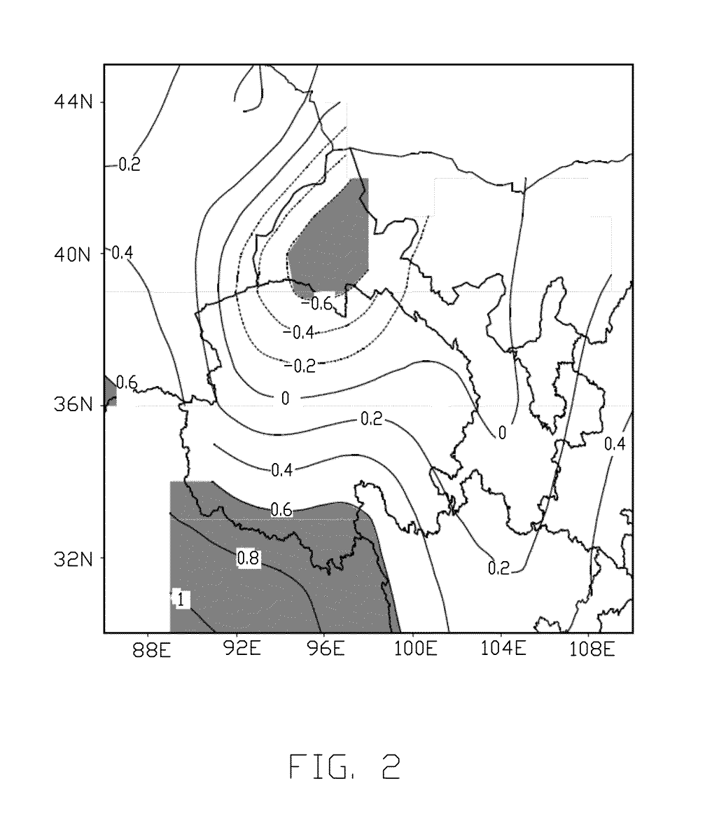

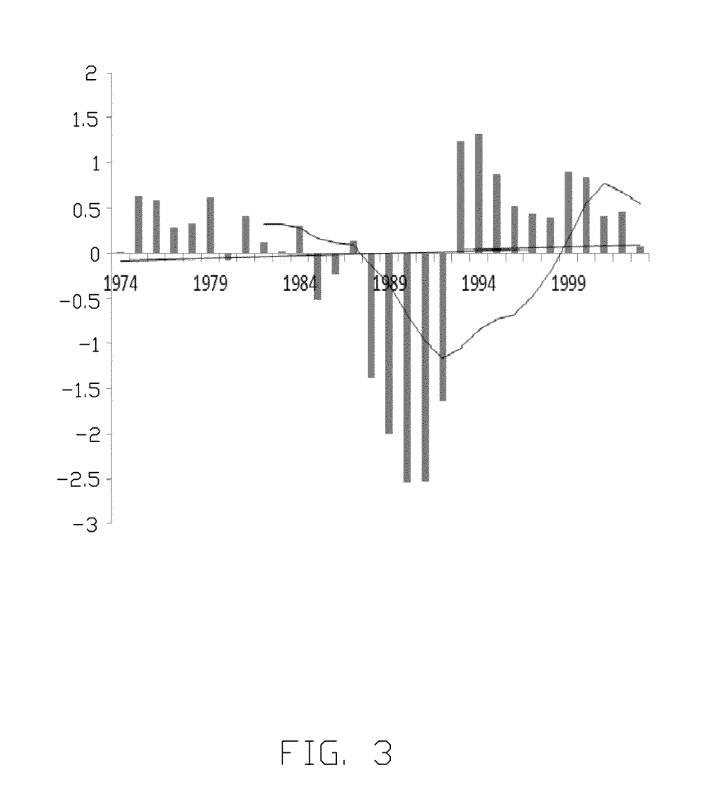

In step (d), while cumulative variance contributions of the first two rotated loading vectors is about 32.8%, the absolute value of loading which greater than or equal to 0.6 can be set as the dividing standard to divide irradiance regions. Referring to FIG. 2 and FIG. 3, the two primary irradiance regions in the annual total radiation amount data in Gansu Province can be obtained.

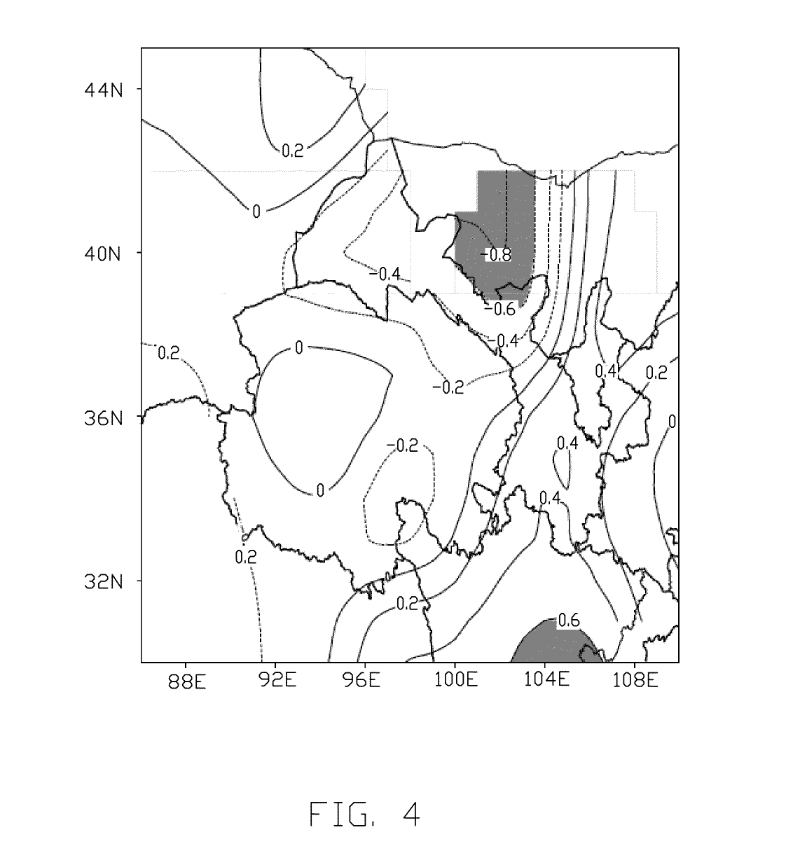

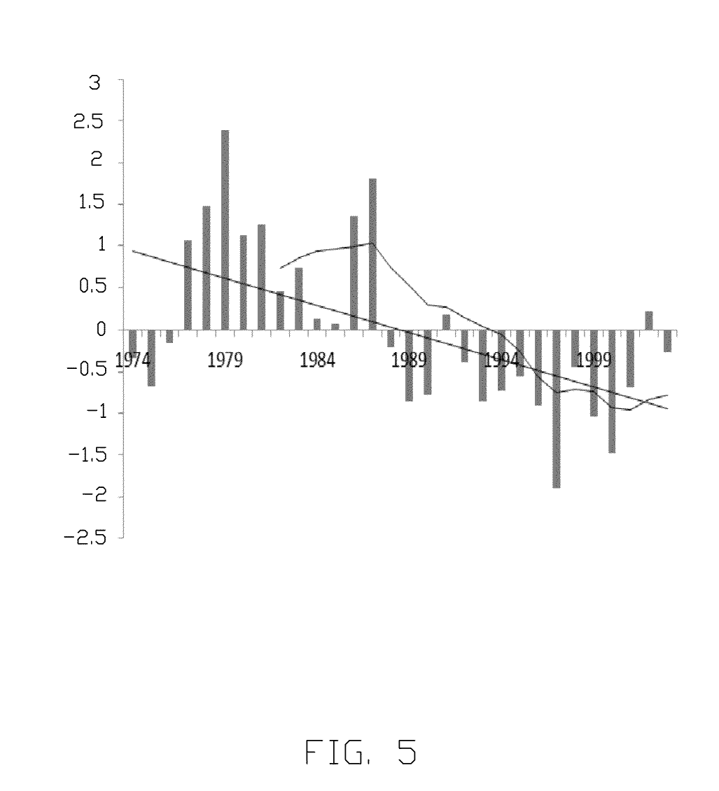

A first rotated loading vector with highest values of the annual total radiation amount data is located near Jiuquan in northwest of Gansu Province. In 1980s, there is a large amount of radiation, then the radiation began to decline, there is a significant interdecadal feature. Referring to FIG. 4 and FIG. 5, a second rotated loading vector with highest values is in the northern part of the Hexi Corridor. The radiation is lower before 1984, then the radiation began ascending. Thus there is also a significant interdecadal feature.

The method of dividing irradiance regions based on rotated empirical orthogonal function confirms the results of the average distribution of the total radiation. The total amount of radiation in Jiuquan during past three decades has significant local variation features. Because changing trend of the total radiation is consistent, the stations within the region can be regarded as representative stations.

The method of dividing irradiance regions based on rotated empirical orthogonal function has the following advantages. The defects of poor stability, low energy conversion efficiency, poor environmental friendliness and the like in the prior art can be overcome to realize the advantages of good stability, high energy conversion efficiency and good environmental friendliness.

Depending on the embodiment, certain of the steps of methods described may be removed, others may be added, and that order of steps may be altered. It is also to be understood that the description and the claims drawn to a method may include some indication in reference to certain steps. However, the indication used is only to be viewed for identification purposes and not as a suggestion as to an order for the steps.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A method of dividing irradiance regions based on rotated empirical orthogonal function, the method comprising:
performing standardized matrix averaging on annual total radiation amount data;
performing empirical orthogonal function decomposition on an annual total radiation variable field matrix based on the standardized matrix averaging result of the annual total radiation amount data;
calculating a variance contribution rate and an accumulative variance contribution rate by rotating a load matrix and a factor matrix according to a varimax orthogonal rotation principle based on the empirical orthogonal function decomposition result of the annual total radiation variable field matrix; and
dividing irradiance regions according to results of the variance contribution rate and the accumulative variance contribution rate.

2. The method of claim 1, wherein the performing standardized matrix averaging on annual total radiation amount data comprises:
$$\overline{x} = \frac{1}{m} \frac{1}{n} {\sum }_{i = 1}^{m} {\sum }_{j = 1}^{n} {x}_{ij}^{′} ,$$
wherein x′ᵢⱼ represents the radiation data 1≦i≦m, 1≦j≦n, m represents the length of time, and n represents the quantity of observation stations.

3. The method of claim 2, wherein:
$${x}_{ij} = \frac{{x}_{ij}^{′} - \overline{x}}{\sqrt{{\sum }_{i = 1}^{n} {\sum }_{j = 1}^{m} {( {x}_{ij}^{′} - \overline{x} )}^{2}}} ,$$
wherein 1≦i≦m, 1≦j≦n.

4. The method of claim 1, wherein performing empirical orthogonal function decomposition on the annual total radiation variable field matrix comprises:
constructing the radiation amount data into an annual total radiation variable matrix X_{n×m}:
$$X = [ \begin{matrix}{x}_{11} & {x}_{12} & … & {x}_{1 j} & … & {x}_{1 n} \\ {x}_{21} & {x}_{22} & … & {x}_{2 j} & … & {x}_{2 n} \\ ⋮ & ⋮ & & ⋮ & & ⋮ \\ {x}_{i 1} & {x}_{i 2} & & {x}_{ij} & & {x}_{in} \\ ⋮ & ⋮ & & ⋮ & & ⋮ \\ {x}_{m 1} & {x}_{m 2} & … & {x}_{mj} & … & {x}_{mm}\end{matrix} ] ;$$
wherein n represents space points, and m represents time points;
decomposing the annual total radiation variable field matrix into a total of products of space functions and time functions:
X_{n×m}=V_{n×n}T_{n×m};
wherein each column of V_{n×n} represents normalized feature vectors of matrix
$$\frac{1}{m} {XX}^{T} ,$$
and X^{T} is transposed matrix of X; T_{n×m} represents weighting coefficients of eigenvectors.

5. The method of claim 4, wherein T_{n×m} is standardized as F: F=Λ^{-1/2}·T, wherein Λ is a diagonal matrix of eigenvalues of the matrix
$$\frac{1}{m} {XX}^{T} .$$

6. The method of claim 5, wherein while L=V·Λ^{1/2}, a matrix A=V·Λ^{1/2}·Λ^{-1/2}·T=LF, wherein L is factor loading matrix, matrix F is factor matrix, and L is an correlation matrix between the matrix A and the matrix F.

7. The method of claim 6, wherein the matrix L and the matrix F are rotated based on varimax orthogonal rotation principle, wherein a sum of relative variances of square elements in each column of matrix L is maximum.

8. The method of claim 7, wherein while a plurality of first p factors are selected, then:
$$S = {\sum }_{j = 1}^{p} [ \frac{1}{n} {\sum }_{i = 1}^{n} {( \frac{{l}_{ij}^{2}}{{h}_{i}^{2}} )}^{2} - ( \frac{1}{n} {\sum }_{i = 1}^{n} {( \frac{{l}_{ij}^{2}}{{h}_{i}^{2}} )}^{2} ]$$
is maximum;
wherein
$${h}_{i}^{2} = {\sum }_{j = 1}^{p} {l}_{ij}^{2} ,$$
lᵢⱼ is the element of matrix L.

9. The method of claim 8, wherein the calculating variance contribution rate and the accumulative variance contribution rate satisfy:
$${\sum }_{i = 1}^{m} {v}_{ik} {v}_{il} = 1 , while k = 1$$
$${\sum }_{j = 1}^{n} {t}_{kj} {v}_{lj} = 0 , while k \neq 1 ;$$
wherein vₖ is the feature vectors.

10. The method of claim 9, wherein the variance contribution rate of vₖ is:
$$\frac{{λ}_{k}}{{\sum }_{k = 1}^{m} {λ}_{k}} \times 100 \% ;$$
and
the cumulative variance contribution rate of the first k spaces is:
$$\frac{{\sum }_{k = 1}^{k} {λ}_{k}}{{\sum }_{k = 1}^{m} {λ}_{k}} \times 100 \% .$$

11. The method of claim 10, further comprising a significance test to the cumulative contribution ratio by calculating error range of eigenvalues λᵢ:
$${e}_{j} = {{λ}_{j} ( \frac{2}{n} )}^{\frac{1}{2}} ,$$
wherein n is sample size.

12. The method of claim 11, wherein each adjacent two eigenvalues λᵢ and λᵢ₊₁ satisfies:
λᵢ+λᵢ₊₁≧eⱼ.

13. The method of claim 12, wherein an absolute value of loading which greater than or equal to 0.6 is set as a dividing standard to divide irradiance regions.
